(19) United States
(12) Patent Application Publication
(10) Pub. No.: US 2001/0051974 A1
(43) Pub. Date: Dec. 13, 2001

(54) METHOD AND APPARATUS FOR AUTOMATIC GENERATION OF DATA INTERFACES

(76) Inventor: RON SAAD, WHIPPANY, NJ (US)

Correspondence Address: KEVIN M. MASON, RYAN, MASON & LEWIS, LLP, 1300 POST ROAD, SUITE 205, FAIRFIELD, CT, 06430, US

(21) Appl. No.: 09/102,871

(22) Filed: Jun. 23, 1998

(51) Int. Cl. G06F 15/16; G06F 7/00

(52) U.S. Cl. 709/202; 707/10

(57) ABSTRACT

A message interface generator is disclosed that generates code routines that convert data elements between proprietary binary formats of one or more computer systems and a portable machine and software generation system independent message format, referred to herein as the “independent message format.” Thus, two systems can communicate data using the uniform independent message format, notwithstanding the proprietary binary formats of either system. The message interface generator automatically generates conversion code from existing data definitions to permit two systems to communicate using the uniform independent message format. The conversion code converts data elements of a given data type to and from the proprietary binary format of each system and the independent message format used on the common communication channel. The independent message format includes a predefined (but arbitrary) standard for each data type to be communicated between the two systems. A data element is transferred between two systems using the independent message format by providing a message indicator header file containing a message description directive and a reference to the header file defining the data element. The message description directive indicates that conversion code should be generated for the indicated data element. The message interface generator includes a tool that analyzes an input file for one or more predefined (but arbitrary) keywords, such as the “message” keyword, to initiate generation of the conversion code for each desired data element.

### CROSS REFERENCE TO RELATED APPLICATIONS

The present invention is related to United States Patent Application entitled “Method And Apparatus For Automatic Generation Of Published Data Interfaces,” (Attorney Docket Number Saad 3) and United States Patent Application entitled “Method And Apparatus For Automatic Generation Of A Name-Value Data Interface,” (Attorney Docket Number Saad 5), each filed contemporaneously herewith, assigned to the assignee of the present invention and incorporated by reference herein.

### FIELD OF THE INVENTION

The present invention relates to a method and apparatus for transferring data between different computer systems, and more particularly, to a method and apparatus for automatically generating code routines that convert data types between proprietary binary formats and a portable machine and software generation system independent message format.

### BACKGROUND OF THE INVENTION

Programmers currently use many high-level programming languages such as C, C++ and Pascal. These programming languages place few, if any, limitations on what a programmer can implement in software, allowing a program to perform virtually any task that may be performed by the underlying hardware. The applications that have been developed using such programming languages, together with the hardware upon which such applications execute, are often referred to as legacy systems.

Legacy systems often use proprietary binary communication messages for control and data interchange. The definitions for the message formats are typically placed in “header files” in the form of data structure definitions, which describe the various data elements contained in each message. The data structure definitions are processed by the software generation systems (such as compilers, assemblers, and link editors) to produce a binary representation of the data. The binary format of the data is often machine and compilation system dependent, since the language definitions permit the compilation systems some flexibility in translating these language constructs to the underlying hardware, thereby resulting in potentially different byte orders, structure alignment, and other data formatting problems on different, communicating machines. For example, some data formats place the highest ordered bits first, while other formats place the lowest ordered bits first. Thus, the same data structure definition, when compiled on different machines or using different compilation systems, may result in a different binary representation of the data, and thus would not be properly interpreted by the software if it were transferred unmodified between such systems.

Accordingly, when legacy systems are required to communicate with other systems, manual effort is typically required to create a compatible set of data structure definitions for the new system, such that the same binary format will result. Creating such definitions manually is a time consuming effort.

Many systems have adopted newer methods for supporting communications, such as the CORBA Interface Definition Language (IDL), described in CORBA v2.1 Specification (Object Management Group August, 1997), or the External Data Representation specification (XDR), proposed by Sun Microsystems' Network Working Group. These newer methods require a new set of definitions to be created, describing the interfaces between the systems in a format or language specific to the communication method chosen. The created specification is then processed, by tools associated with the communication method, to produce interface code, typically in a language such as C or C++, which the communicating systems can then use to interact or communicate with each other. While these newer methods offer techniques for intersystem communication, they do not address existing message structure definitions and message sets used by systems that have not adopted these new methods, such as legacy systems. Additionally, these newer methods require more training and education for programmers and developers, and many organizations opt to continue using the “old style” data structure definitions in their development to avoid the cost and overhead of retraining the development staff. These “old style” data structure definitions and header files will be referred to as traditional data structure definitions and header files, respectively. Systems developed in this manner will be referred to herein as “legacy systems.”

### SUMMARY OF THE INVENTION

The present invention solves the above-identified problems by providing an automated technique for communicating data between different computer systems that does not require the hand crafting of new data structure definitions to enable the proper interpretation of the binary layout. In addition, the present invention automatically generates code for converting data types between proprietary binary formats and a machine and software generation system independent message format, so that systems having different proprietary binary formats can communicate using the independent message format.

Generally, according to one aspect of the invention, a message interface generator is disclosed that generates code routines that convert data elements between proprietary binary formats of one or more systems and a portable machine and software generation system independent message format, referred to herein as the “independent message format.” Thus, the present invention permits two systems to communicate using the uniform independent message format, notwithstanding the proprietary binary formats of each system and that one of the formats may be a predefined format associated with a legacy system.

According to another aspect of invention, the message interface generator automatically generates conversion code from existing traditional data structure definitions to permit the systems to communicate using the uniform independent message format. The conversion code converts data elements of a given data type to and from the proprietary binary format of each system and the independent message format used on the common communication channel. The independent message format includes a predefined (but arbitrary) standard for each data type to be communicated between the two systems.

According to a further aspect of the invention, the message interface generator automatically generates the conversion code without requiring new handcrafted data structure definitions for the messages. A message is marked for transfer between two systems using the independent message format by placing a message description directive in a message indicator header file. The message indicator header file also contains a reference to the traditional header file containing the traditional data structure definitions for the message. The message description directives indicate to the message interface generator that conversion code should be generated for the indicated message. In this manner, existing legacy code is unaffected, and traditional header files may be used for development.

The message interface generator includes a tool (such as a parser) that analyzes a message indicator header file for one or more predefined (but arbitrary) keywords, such as the “message” keyword, as well as the included header file containing the data structure definitions for the message. The tool gathers information (such as a symbol table or data dictionary) from the data structure definitions. Thus, the tool can generate the conversion code for each data element to be transferred in order to convert each data element, if necessary, to the predefined (but arbitrary) independent message format.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment for transferring data between two systems in accordance with the present invention;

FIG. 2 is a schematic block diagram illustrating the developer's workstation of FIG. 1;

FIG. 3A provides the definition of an illustrative data structure from the legacy code of FIG. 1 to be communicated with a new system;

FIG. 3B illustrates a message description directive in accordance with the present invention processed by the message interface generator of FIG. 2;

FIG. 3C illustrates the conversion code produced by the message interface generator of FIG. 2;

FIG. 4A is a schematic diagram of the message interface generator of FIG. 1; and

FIG. 4B is a flow chart describing an exemplary process performed by the message interface generator of FIG. 1.

### DETAILED DESCRIPTION

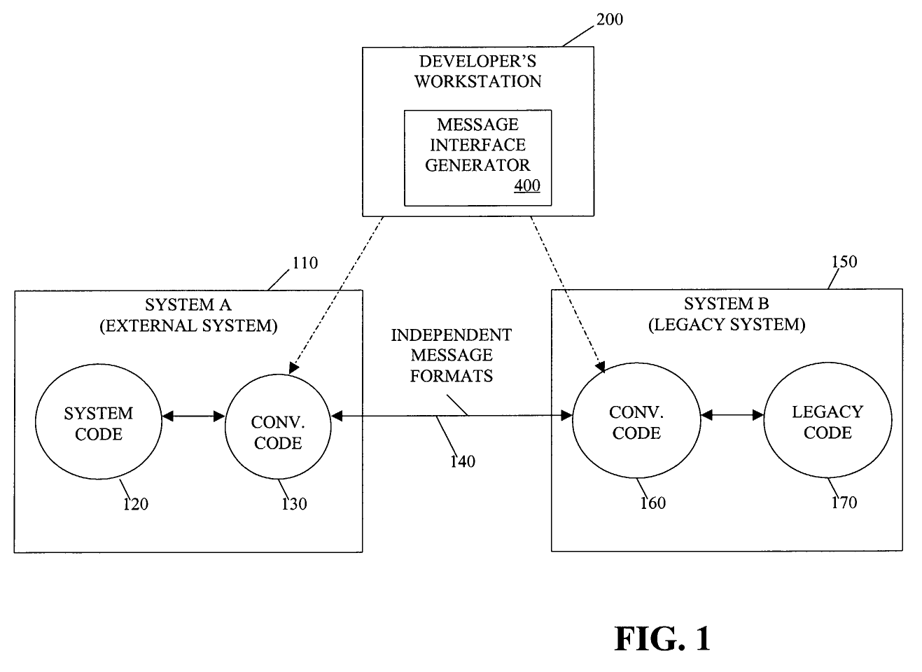

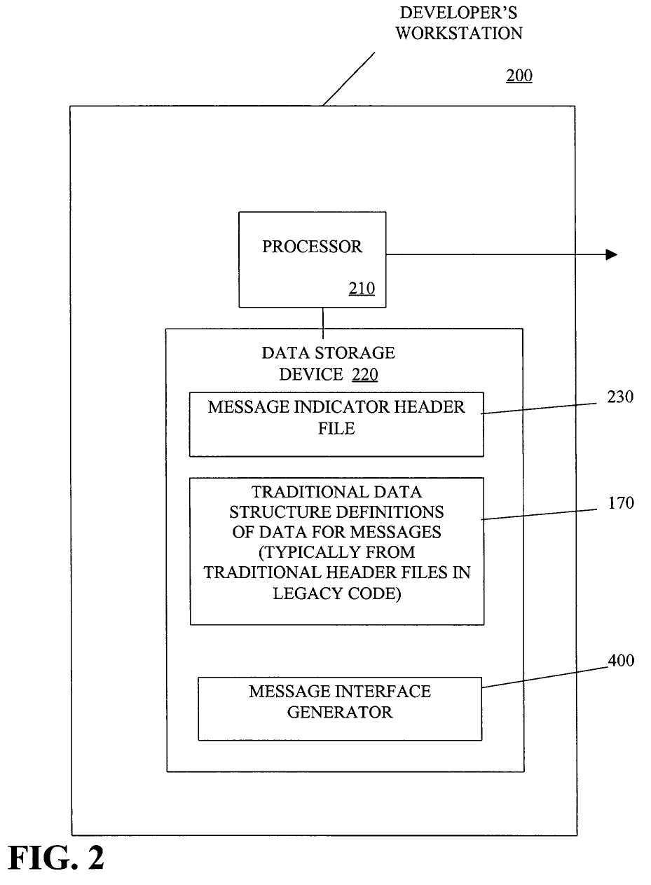

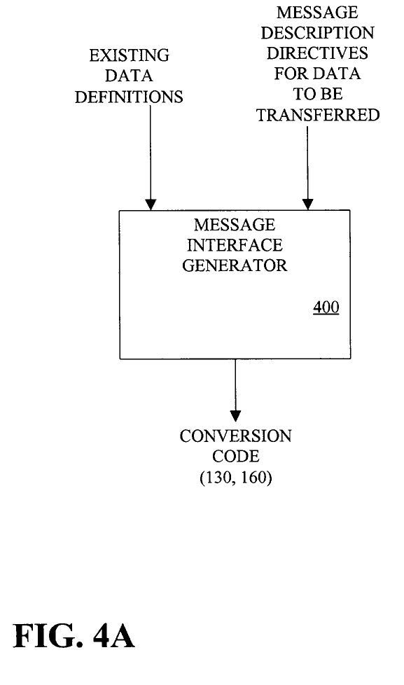

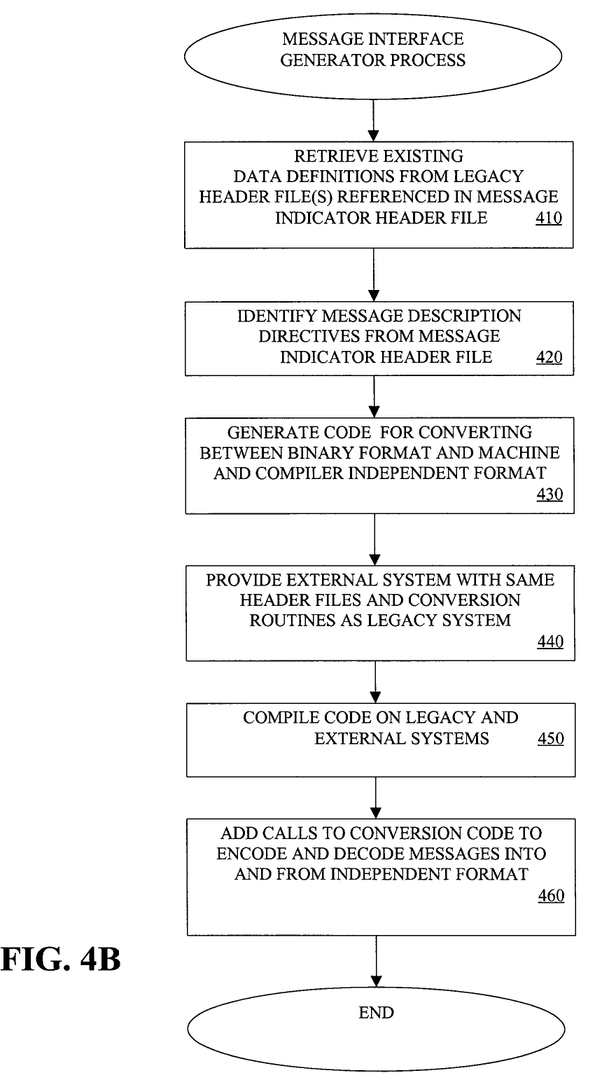

FIG. 1 illustrates a message interface generator 400, discussed further below in conjunction with FIGS. 4A and 4B, that generates code routines that convert data elements between proprietary binary formats of a first system 150, such as a legacy system, and/or a second system 110, such as an external system, and a portable machine and software generation system independent message format, hereinafter referred to as the “independent message format.” In this manner, the two systems 110, 150 can communicate data over a channel 140 in a uniform independent message format, notwithstanding the proprietary binary formats of each system 110, 150 resulting from machine and software generation system dependencies. It is noted that channel 140 can be any communication medium upon which a signal may propagate, as would be apparent to a person of ordinary skill in the art. In one embodiment, the message interface generator 400 is part of a developer's workstation 200, discussed further below in conjunction with FIG. 2. Thus, the message interface generator 400 permits legacy messages from legacy code 170 of the legacy system 150 to be communicated to and from system code 120 of the external system 110.

According to a feature of the present invention, the message interface generator 400 automatically generates conversion code 130, 170, to permit the external and legacy systems 110, 150, respectively, to communicate over the channel 140 in the uniform independent message format. The conversion code 130 converts data elements of a given data type to and from the proprietary binary format of the external system 110 and the independent message format. Likewise, the conversion code 160 converts data elements of a given data type to and from the proprietary binary format of the legacy system 150 and the independent message format. The independent message format includes a predefined (but arbitrary) standard for each data type to be communicated between the two systems 110, 150. For example, the independent message format can utilize ‘low endian’ formats for sending multi-byte integer values. If the external system 110 or the legacy system 150 utilize a different standard for multi-byte integer values, then conversion code 130, 160 is required for the differing system(s) 110, 150.

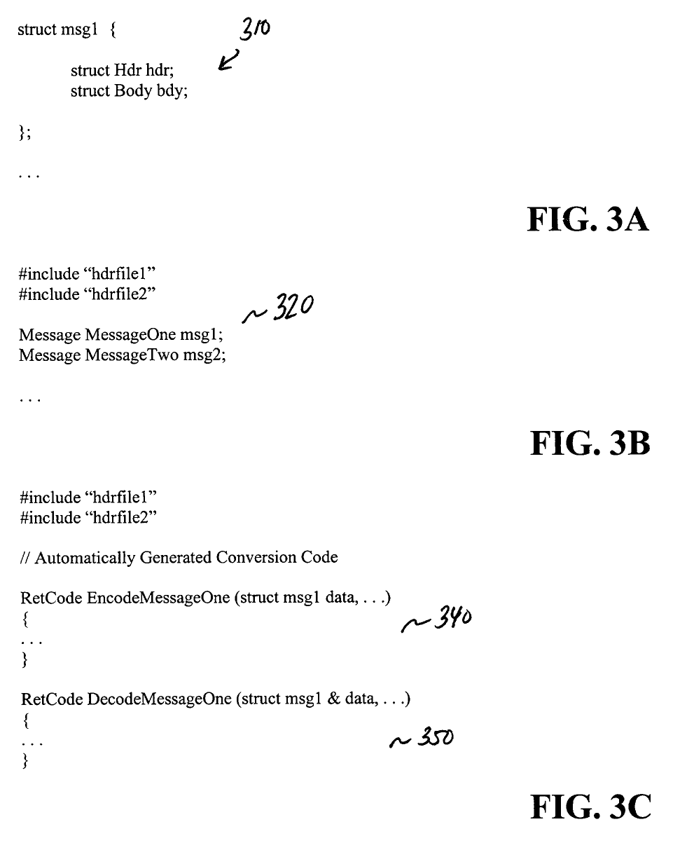

According to a further feature of the invention, the message interface generator 400 automatically generates the conversion code 130, 170 with minimal effort by the programmer and without requiring new descriptions of the data elements to be transferred. As discussed further below in conjunction with FIGS. 2 through 4, if a programmer desires to transfer data elements between the legacy code 170 of the legacy system 150 and the system code 120 of the external system 110 over channel 140 using the independent message format, the programmer merely supplies message description directives in the message indicator header file to indicate to the message interface generator 400 that conversion code should be generated for the indicated messages. As discussed in conjunction with FIG. 3B, the message description directives consist of statements having a predefined (but arbitrary) keyword, such as a “message” keyword, and the corresponding message (data structure) to be transferred.

According to a further feature of the invention, the message interface generator 400 includes a tool (such as a parser) that analyzes a message indicator header file for one or more predefined (but arbitrary) keywords, such as the “message” keyword, as well as the included header file containing the data structure definitions for the message. The tool gathers information (such as a symbol table or data dictionary) from the data structure definitions. Thus, the tool can generate the conversion code for each data element to be transferred in order to convert each data element, if necessary, to the predefined (but arbitrary) independent message format.

As shown in FIG. 2, in order to generate conversion code in accordance with the present invention, the workstation 200, or other computing device, utilized by the programmer or developer, should contain a number of software components and tools. FIG. 2 is a block diagram showing the architecture of an illustrative developer workstation 200. The workstation 200 preferably includes a processor 210 and related memory, such as a data storage device 220, which may be distributed or local. The processor 210 may be embodied as a single processor, or a number of local or distributed processors operating in parallel. The data storage device 220 and/or a read only memory (ROM) are operable to store one or more instructions, which the processor 210 is operable to retrieve, interpret and execute.

The data storage device 220 preferably includes the message indicator header file 230, containing the message description directives and the references to the original header files, which are portions of the legacy code 170, in order to automatically generate conversion code 130, 160 which can then be compiled for each system 110, 150. As discussed further below in conjunction with FIGS. 4A and 4B, the data storage device 220 also includes the message interface generator 400. Thus, the generated code 130, 160 can be built on the legacy and external systems 150, 110, respectively.

FIG. 3A provides the definition 310 of an illustrative data structure, msgl, from the legacy code 170 of FIG. 1. The msgl data structure consists of two elements which are each themselves separate data structures. The msgl data structure is desired to be transferred between the legacy code 170 of the legacy system 150 and the system code 120 of the external system 110 over the channel 140 using the independent message format, in accordance with the present invention.

Thus, as previously indicated, in order to make the msgl data structure available for communication with the external system 110, the programmer adds a message description directive to the message indicator header file, as well as a reference to the original header file where the msgl data structure definition resides. The message description directive 320 for the msgl data structure, shown in FIG. 3B, indicates to the message interface generator 400 that conversion code should be generated for the msgl data structure. As shown in FIG. 3B, the message description directive 320 for the msgl data structure consists of a statement having a predefined (but arbitrary) keyword, such as a “message” keyword, and the name of the msgl data structure.

As discussed further below in conjunction with FIG. 4B, the analysis tool of the message interface generator 400 will analyze the input file and generate the conversion code 340, 350, shown in FIG. 3C, in response to the message description directive 320 for the msgl data structure, shown in FIG. 3B. The conversion code 340 converts the elements of the msgl data structure from the proprietary binary format of the legacy system 150 to the independent message format. Likewise, the conversion code 350 converts the elements of the msgl data structure from the independent message format to the proprietary binary format of the legacy system 150. It is noted that the precise conversion code 340, 350 required to convert the elements of the msgl data structure between the proprietary binary format of the legacy system 150 and the independent message format is entirely dependent on the respective formats selected and would be apparent to a person of ordinary skill in the art.

As previously indicated, the message interface generator 400, shown in FIG. 4A, generates code routines that convert data elements between proprietary binary formats of systems 110, 150 and a portable independent message format. The message interface generator 400 takes existing data definitions for the data to be transferred between the systems 110, 150, as well as the message description directives discussed above in conjunction with FIG. 3B to automatically generate the conversion code 130, 160, required for the systems 110, 150, respectively. It is noted that after the conversion code 130, 160 is generated, a programmer can add calls to the generated code to execute the desired encoding and decoding of messages. These added calls include, for example, an indication of the specific union members utilized if the message(s) contain a union.

FIG. 4B illustrates the message interface generator 400 from a process perspective. As shown in FIG. 4B, the message interface generator 400 initially retrieves the existing data definitions from the legacy header file(s) referenced in the message indicator header file 230 during step 410. Thereafter, the analysis tool included in the message interface generator 400 analyzes the input file during step 420 to identify any message description directives that were placed in the message indicator header file(s). The message interface generator 400 then automatically generates the code 130, 160 during step 430 for converting between the proprietary binary formats of the systems 110, 150 and the independent message format. The external system 110 is provided with the same header files and conversion routines as the legacy system 150 during step 440, and the generated conversion code 130, 160 is then compiled on the external and legacy systems 110, 150, respectively, during step 450. Calls are added to the conversion code 130, 160 during step 460 to encode and decode messages.

It is to be understood that the embodiments and variations shown and described herein are merely illustrative of the principles of this invention and that various modifications may be implemented by those skilled in the art without departing from the scope and spirit of the invention. In addition, it is to be understood that the source code provided herein is meant to illustrate the principles of the present invention, and is not intended to compile correctly.

I claim:

1. A method for enabling the communication of a data element between a first computer system and a second computer system, said method comprising the steps of:
providing a statement in a header file to indicate that the data element is to be communicated between said systems;
analyzing said header file to identify said provided statements;
analyzing definitions of said data elements referenced in said header file; and
processing said analyzed header file to generate conversion code to convert said data element to an independent message format for transfer between said first and second computer systems.

2. The method according to claim 1, wherein a portion of said conversion code converts said data element between the proprietary binary format of the first system and the independent message format.

3. The method according to claim 1, wherein a portion of said conversion code converts said data element between the proprietary binary format of the second system and the independent message format.

4. The method according to claim 1, wherein the independent message format includes a predefined standard for the data type associated with said data element.

5. The method according to claim 1, wherein said conversion code is generated without requiring a new data structure definition of the data element.

6. A method of enabling the communication of a data element from a first computer system to a second computer system, said method comprising the steps of:
converting said data element from a proprietary binary format of said first computer system to an independent message format, said converting step performed by code generated from an existing definition of said data element; and
transferring said converted data element in said independent message format to said second computer system.

7. The method according to claim 6, wherein the independent message format includes a predefined standard for the data type associated with said data element.

8. The method according to claim 6, wherein said conversion code is generated without requiring a new data structure definition of the data element.

9. The method according to claim 6, further comprising the step of said second computer system having received said data element in said independent message format, converting said data element from said independent message format to a proprietary binary format of said second computer system, said converting step performed by code generated from an existing definition of said data element.

10. A method performed by a first computer system for enabling the receiving of a data element from a second computer system, said method comprising the steps of:
receiving said data element in an independent message format; and
converting said data element from independent message format to a proprietary binary format of said first computer system, said converting step performed by code generated from an existing definition of said data element.

11. The method according to claim 10, wherein the independent message format includes a predefined standard for the data type associated with said data element.

12. The method according to claim 10, wherein said conversion code is generated without requiring a new data structure definition of the data element.

13. The method according to claim 10, further comprising the step of said second computer system converting said data element from a proprietary binary format of said second computer system to said independent message format, said converting step performed by code generated from an existing definition of said data element, to enable transmitting said data element to said first computer system in said independent message format.

14. A software tool comprising:
means for identifying a statement indicating that a data element is to be communicated between two computer systems;
means for analyzing legacy system code header files with existing data definitions; and
means for generating conversion code in response to said statement to communicate said data element between said two computer systems using an independent message format.

15. The software tool according to claim 14, wherein a portion of said conversion code converts said data element between the proprietary binary format of a system and the independent message format.

16. The software tool according to claim 14, wherein the independent message format includes a predefined standard for the data type associated with said data element.

17. The software tool according to claim 14, wherein said conversion code is generated without requiring a new data structure definition of the data element.
